(19) United States
(12) Patent Application Publication
(10) Pub. No.: US 2006/0212266 A1
(43) Pub. Date: Sep. 21, 2006

(54) EXAMINING DEVICE

(76) Inventor: Chin-Liang Chen, Penghu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,037

(22) Filed: Aug. 26, 2005

(30) Foreign Application Priority Data
Mar. 1, 2005 (TW) 94106002

(51) Int. Cl. G21C 17/00

(52) U.S. Cl. 702/182

(57) ABSTRACT

An examining device adapted for examining a motherboard of an electronic product is provided. The motherboard includes a plurality of power rails. After the electronic product is turned on, the power rails are sequentially turned on. The examining device includes a plurality of coding/decoding units and a status-indication unit. Each of the coding/decoding units is coupled to each of the power rails to receive a signal output from the turned-on power rail. Coded/decoded signals are output from the coding/decoding units according to the signals. The status-indication unit is coupled to the coding/decoding units to receive the coded/decoded signals, and is driven according to the received coded/decoded signals. The status-indication unit shows the turn-on statuses of the power rails so that the time for debugging the motherboard is reduced.

### CROSS-REFERENCE TO RELATED APPLICATION

This application claims the priority benefit of Taiwan application serial no. 94106002, filed on Mar. 1, 2005. All disclosure of the Taiwan application is incorporated herein by reference.

### BACKGROUND OF THE INVENTION

1. Field of the Invention

The present invention relates to an examining apparatus, and more particularly, to an examining apparatus adapted to examining the turn-on power sequence of a motherboard.

2. Description of the Related Art

With the advance of electronic technology, various electronic products have been widely used in different industries and consumer products, specially in information electronic devices and household appliances. In order to perform specific functions of these electronic products, almost every electronic product has a motherboard composed of some electronic units and circuit boards. Wherein, the electronic units are assembled on the circuit boards, and are electrically coupled to each other through the internal lines of the circuit boards.

During the manufacturing of the electronic products, motherboards of these electronic products are tested after a specific process is finished. The subsequent process for the passed motherboards is then performed to avoid accumulating process errors and enhance the yield of the whole process. In the motherboard of a computer, for example, the motherboard usually comprises many power rails. While the computer is turned on, the power rails are sequentially turned on so that the computer performs the subsequent turn-on process.

However, at the beginning of the turn-on process, i.e., the bring-up status, the computer sometimes cannot be turned on resulting from incorrect circuit design of the turn-on power sequence in the motherboard. The present examining method is to manually test and find out which power rail fails. However, this debugging method is time-consuming and fails to achieve the modern-day efficiency trend.

### SUMMARY OF THE INVENTION

Accordingly, the present invention is directed to an examining apparatus to examine whether the turn-on power of the motherboard operates normally so as to reduce the time for debugging the motherboard.

The present invention provides an examining apparatus adapted for examining a turn-on sequence of a motherboard in an electronic product. Wherein, the motherboard comprises a plurality of power rails. After a turn-on of the electronic product, the power rails are sequentially turned on. The examining device comprises a plurality of coding/decoding units and a status-indication unit. Each of the coding/decoding units is coupled to one of the power rails corresponding thereto to receive the signal output from the turned-on power rail. According to the received signal, a coded/decoded signal is output. The status-indication unit is coupled to the coding/decoding unit for receiving the coded/decoded signal for driving.

According to an embodiment of the present invention, the status-indication unit described above comprises a light-emitting device or a display device. In an embodiment, the status-indication unit can be, for example, a light-emitting diode or seven-segment display.

According to an embodiment of the present invention, the status-indication unit described above further comprises a counter, which is coupled between the coding/decoding units, and the light-emitting device or the display device to count the number of the coded/decoded signals output to the status-indication unit. In an embodiment, the counter can be, for example, a binary counter.

Accordingly, examiners may easily determine whether any one power rail on the motherboard normally operates according to the status-indication unit. With the examining apparatus of the present invention, the time for debugging the motherboard can be reduced.

The above and other features of the present invention will be better understood from the following detailed description of the preferred embodiments of the invention that is provided in communication with the accompanying drawings.

### BRIEF DESCRIPTION OF THE DRAWINGS

FIG. 1 is a block diagram showing an examining apparatus according to an embodiment of the present invention.

FIG. 2 is a block diagram showing an examining apparatus according to another embodiment of the present invention.

### DESCRIPTION OF SOME EMBODIMENTS

The present invention provides an examining apparatus to examine a turn-on power of a motherboard in an electronic product so as to reduce the time for debugging turn-on power sequence in the motherboard. The following is an embodiment of the present invention. The present invention, however, is not limited thereto. One of ordinary skill in the art may modify the embodiment of the present invention without departing from the scope of the invention. Those modifications still fall within the scope of the invention.

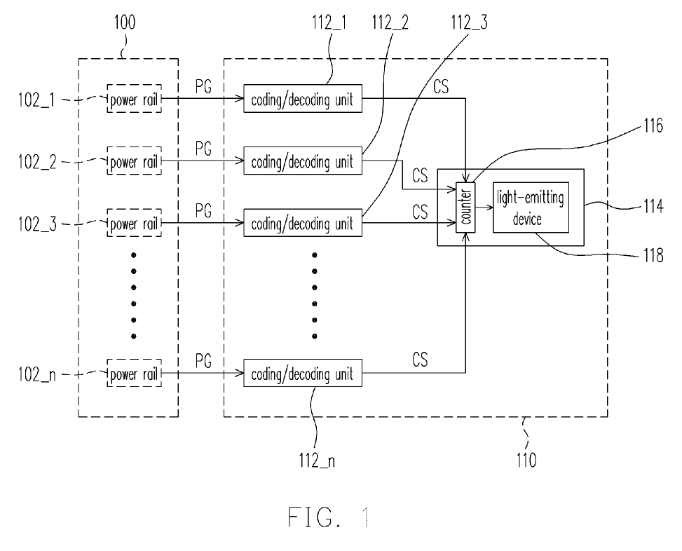

FIG. 1 is a block diagram showing an examining apparatus according to an embodiment of the present invention. Referring to FIG. 1, the examining apparatus 110 examines the turn-on power sequence of the motherboard 100 of an electronic product (not shown). In this embodiment, the electronic product can be, for example, a computer; the motherboard 100 can be, for example, a computer motherboard. Wherein, the motherboard 100 comprises a plurality power rails 102_1, 102_2, 102_3, . . . , 102_{—}n. That is, the motherboard 100 comprises n power rails. In this embodiment, n is a positive integer. One of ordinary skill in the art knows that n depends on the type of the motherboard. The present invention does not limit the number of n.

Accordingly, after the electronic product is turned on, the power rails 102 are sequentially turned on. For example, under the normal operation, after the power rail 102_1 is turned on, the power rail 102_1 turns on the power rail 102_2. After the power rail 102_2 is turned on, the power rail 102_2 turns on the power rail 102_3. Other power rails are turned on following this sequence.

Referring to FIG. 1, the examining apparatus 110 mainly comprises a status-indication unit 114 and a plurality of coding/decoding units 112_1, 112_2, 112_3, . . . , 112_{—}n. Each of the power rails 102_1-102_{—}n outputs a signal PG after turned on. Each of the coding/decoding unit 112_1-112_{—}n is correspondingly coupled to each of the rail power 102_1-102_{—}n, and receives the signal PG output from each of the rail powers 102_1-102_{—}n after turned on. The signals PG are coded/decoded by the coding/decoding unit 112_1-112_{—}n, and then the corresponding coded/decoded signals CS are output to the status-indication unit 114. The status-indication unit 114 is driven according to the received coded/decoded signals CS.

Note that the status-indication unit 114 may comprise the counter 116 and the light-emitting device 118, for example. Wherein, the counter 116 is coupled between the light-emitting device 118 and the coding/decoding units 112_1-112_{—}n. The counter 116 counts the number of the coded/decoded signals CS output from the coding/decoding units 112_1-112_{—}n to the status-indication unit 114. In an embodiment, the counter 116 can be, for example, a binary counter.

Additionally, the light-emitting device 118 is a device composed of n light-emitting diodes (LEDs) (not shown). The LEDs are driven according to the counting result output from the counter 116. For example, if the counting result output from the counter 116 shows that the status-indication unit 114 receives m coded/decoded signals CS, m LEDs are driven to emit light. In this embodiment, m is smaller than n.

In order for one of ordinary skill in the art to understand the application of the present invention, the following are steps for examining the motherboard by using the examining apparatus of the present invention.

Referring to FIG. 1, after the electronic product is turned on, the power rails 102_1-102_{—}n of the motherboard of the electronic product are sequentially turned on. The turned-on power rail then outputs the signal PG to the corresponding coding/decoding unit coupled thereto. In detail, after the power rail 102_1 is turned on, the power rail 102_1 outputs the signal PG to the coding/decoding unit 112_1. The coding/decoding unit 112_1 outputs the coded/decoded signal CS to the status-indication unit 114 so as to drive the status-indication unit 114 according to the signal PG. In this embodiment, the status-indication unit 114 comprises, for example, the counter 116 and the light-emitting device 118. The light-emitting device 118 comprises n LEDs, for example. Accordingly, after receiving the coded/decoded signal CS output from each turned-on power rail, the counter 116 outputs a counting result to the light-emitting device 118. Based on the counting result, the light-emitting device 118 determines the number of the LEDs, which are turned on. Accordingly, an operator knows how many power rails normally operate according to the status-indication unit 114. Moreover, since the power rails 102_1-102_{—}n are sequentially driven, as long as the number of the normally-operating power rails is known, it is enough to determine which power rail fails to emit. For example, if only two LEDs of the light emitting device 118 emit, then the power rail 102_3 fails.

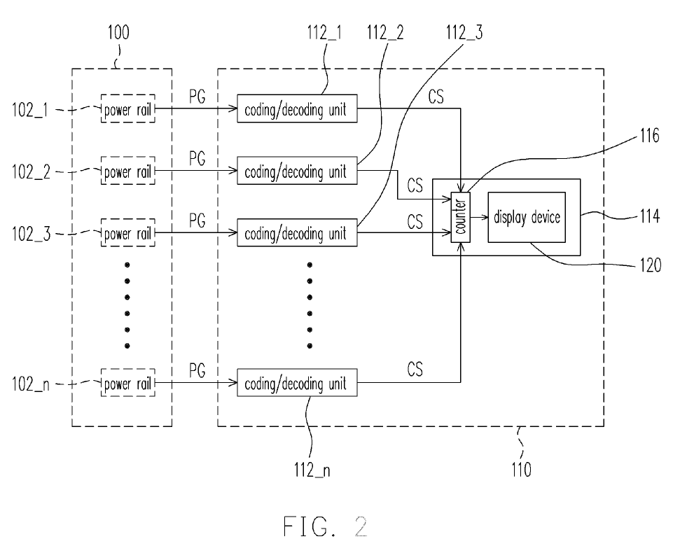

Note that in this embodiment, the examining apparatus 110 informs the examiner of the examination result of the turn-on power of the motherboard 100 through the light-emitting device 118. The present invention, however, is not limited thereto. In another embodiment of the present invention, the examining apparatus 110 may inform the examiner of the examination result of the turn-on power of the motherboard 100 through the display device 120 shown in FIG. 2. Wherein, the display device 120 can be, for example, a seven-segment display. The display device 120 may display a number according to the counting result output from the counter 116. For example, if the counter 116 receives two coding/decoding signals, the display device 120 shows “2”. That is, the power rail 102_3 fails.

Accordingly, while the examining apparatus of the present invention examines the turn-on power sequence of the motherboard, if one of the power rails of the motherboard fails, an examiner may easily determine which power rail fails through the status-indication unit of the examining apparatus, and properly handles the failing power rail. Thus, the time to debug the motherboard can be reduced by using the examining apparatus of the present invention.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

What is claimed is:

1. An examining device, adapted for examining a turn-on sequence of a motherboard of an electronic product, wherein the motherboard comprises a plurality of power rails, which are sequentially turned on after the electronic product is turned on, the examining device comprising:
a plurality of coding/decoding units, each of the coding/decoding units being coupled to one of the power rails corresponding thereto, wherein when one of the power rails is turned on, a signal is output to the coding/decoding unit, and the coding/decoding unit outputs a coded/decoded signal according to the signal; and
a status-indication unit, coupled to the coding/decoding unit and adapted for receiving the coded/decoded signal for driving.

2. The examining device of claim 1, wherein the status-indication unit comprises a light-emitting device or a display device.

3. The examining device of claim 2, wherein the light-emitting device is a light-emitting diode.

4. The examining device of claim 2, wherein the display device a seven-segment display.

5. The examining device of claim 2, wherein the status-indication unit further comprises a counter, which is coupled between the coding/decoding units and the light-emitting device or the display device.

6. The examining device of claim 5, wherein the counter is a binary counter.
